(19) United States
(12) Patent Application Publication
(10) Pub. No.: US 2025/0221801 A1
(43) Pub. Date: Jul. 10, 2025

(54) STRIPE INTENSITY ADJUSTMENT METHOD AND MEDICAL SCANNING APPARATUS

(71) Applicant: QISDA CORPORATION, Taoyuan City (TW)

(72) Inventors: Yan-Hong Chen, Taichung City (TW); Chen-Cheng Chiang, Taipei City (TW); Ching-Huey Wang, Taoyuan City (TW)

(73) Assignee: QISDA CORPORATION, Taoyuan City (TW)

(21) Appl. No.: 19/010,147

(22) Filed: Jan. 5, 2025

(30) Foreign Application Priority Data
Jan. 9, 2024 (CN) 202410029528.5

(51) Int. Cl. A61C 9/00; G06V 10/60

(52) U.S. Cl. CPC A61C 9/006; G06V 10/60

(57) ABSTRACT

A stripe intensity adjustment method is applied to a medical scanning apparatus which projects detection stripes onto a target object. The stripe intensity adjustment method includes acquiring a stripe pattern reflected by the target object, utilizing a plurality of intensity setting rules to adjust the medical scanning apparatus for acquiring a plurality of gathering intensity values of the stripe pattern, generating an intensity index lookup table in accordance with a trend of the plurality of gathering intensity values, acquiring an intensity setting parameter from the intensity index lookup table via a first indication intensity value of the stripe pattern, utilizing the intensity setting parameter to adjust the medical scanning apparatus for acquiring a second indication intensity value of the stripe pattern, and transforming the stripe pattern into a 3D outline of the target object when the second indication intensity value conforms to a predefined intensity range.

### BACKGROUND OF THE INVENTION

### 1. Field of the Invention

The present invention relates to a stripe intensity adjustment method and a medical scanning apparatus, and more particularly, to a stripe intensity adjustment method of increasing scanning quality and efficiency and a related medical scanning apparatus.

### 2. Description of the Prior Art

A conventional digital dental scanner includes a lighting unit, a scanning unit and a processing unit. External illumination light is difficult to project into the mouth of the patient, so the conventional digital dental scanner uses the lighting unit to provide the stable illumination light to project onto the teeth; the scanning unit receives the stripe pattern reflected by the teeth, and transmits the stripe pattern to the processing unit for computing the 3D model of the teeth. However, the stripe pattern is easily affected by the surface color and the material feature of the teeth, such as food residues, tartar or cavities on the teeth, which results in uneven intensity distribution of the stripe pattern, thereby reducing an accuracy of the 3D teeth model created by the processing unit. Therefore, design of an intensity adjustment method applied to oral scanning is an important issue in the related industry.

### SUMMARY OF THE INVENTION

The present invention provides a stripe intensity adjustment method of increasing scanning quality and efficiency and a related medical scanning apparatus for solving above drawbacks.

According to the claimed invention, a stripe intensity adjustment method is applied to a medical scanning apparatus which projects detection stripes onto a target object. The stripe intensity adjustment method includes acquiring a stripe pattern reflected by the target object, utilizing a plurality of intensity setting rules to adjust the medical scanning apparatus for acquiring a plurality of gathering intensity values of the stripe pattern respectively, generating an intensity index lookup table in accordance with a variety trend of the plurality of gathering intensity values, computing a first indication intensity value of the stripe pattern when noise around the stripe pattern is filtered, acquiring an intensity setting parameter via an index value of the intensity index lookup table in accordance with the first indication intensity value, utilizing the intensity setting parameter to adjust the medical scanning apparatus for acquiring a second indication intensity value of the stripe pattern, and transforming the stripe pattern into a 3D outline of the target object when the second indication intensity value conforms to a predefined intensity range.

According to the claimed invention, the stripe intensity adjustment method further includes acquiring a center line of each stripe area of the stripe pattern, setting a stripe range in the stripe area based on the center line in accordance with a predefined stripe width, and computing a pixel grey level of the stripe range to acquire the first indication intensity value of the stripe pattern after filtering out the noise.

According to the claimed invention, each of the plurality of intensity setting rules is setting a gain value, an exposure period, a driving current, an actuation point of time, an ending point of time and/or a duration length of a lighting unit of the medical scanning apparatus. Each of the plurality of intensity setting rules is setting a gain value, an exposure period, a sharpness value, a contrast value, an actuation point of time, an ending point of time and/or a duration length of an image receiver of the medical scanning apparatus.

According to the claimed invention, the stripe intensity adjustment method further includes setting an allowable intensity range, dividing the allowable intensity range into a plurality of intensity groups in accordance with a predefined intensity interval, and setting related index vales by the plurality of intensity setting rules and the plurality of intensity groups to generate the intensity index lookup table.

According to the claimed invention, the stripe intensity adjustment method further includes analyzing difference between the plurality of gathering intensity values and the predefined intensity range to decide the index value of the intensity index lookup table corresponding to the variety trend.

According to the claimed invention, the stripe intensity adjustment method further includes acquiring another intensity setting parameter via another index value of the intensity index lookup table in accordance with the second indication intensity value when the second indication intensity value does not conform to the predefined intensity range, utilizing the another intensity setting parameter to adjust the medical scanning apparatus for acquiring a third indication intensity value of the stripe pattern, and deciding whether to transform the stripe pattern with the third indication intensity value into the 3D outline of the target object, or to acquire other related index values and related intensity setting parameters from the intensity index lookup table in accordance with the third indication intensity value due to a determination result of whether the third indication intensity value conforms to the predefined intensity range.

According to the claimed invention, the stripe pattern includes a basic stripe sequence with periodic repetition and the basic stripe sequence comprises several stripe areas with different widths. The stripe intensity adjustment method identifies a code of the stripe area based on center coordinates of each stripe area of the stripe pattern and related configuration and related color, so as to transform the stripe pattern into the 3D outline via the code.

According to the claimed invention, a medical scanning apparatus with stripe intensity adjustment function includes an imaging module, a lighting unit, an image receiver and an operation processor. The lighting unit is adapted to project detection stripes onto a target object through the imaging module. The image receiver is adapted to receive a stripe pattern reflected by the target object and passing through the imaging module. The operation processor is electrically connected with the lighting unit and the image receiver. The operation processor is adapted to utilize a plurality of intensity setting rules to adjust the medical scanning apparatus for acquiring a plurality of gathering intensity values of the stripe pattern respectively, generate an intensity index lookup table in accordance with a variety trend of the plurality of gathering intensity values, compute a first indication intensity value of the stripe pattern when noise around the stripe pattern is filtered, to acquire an intensity setting parameter via an index value of the intensity index lookup table in accordance with the first indication intensity value, utilize the intensity setting parameter to adjust the medical scanning apparatus for acquiring a second indication intensity value of the stripe pattern, and transform the stripe pattern into a 3D outline of the target object when the second indication intensity value conforms to a predefined intensity range.

According to the claimed invention, the detection stripes and the stripe pattern pass through the same imaging assembly of the imaging module, or the detection stripes and the stripe pattern respectively pass through a first imaging assembly and a second imaging assembly of the imaging module.

The stripe intensity adjustment method and the related medical scanning apparatus of the present invention can collect data of the target object in advance to set the intensity index lookup table, and can directly and immediately perform exposure compensation on each detection surface of the target object in following operation. When the indication intensity value of the stripe pattern reflected by the target object after filtering out the surrounding noise conforms to the predefined intensity range, the stripe pattern can be transformed into the 3D outline of the target object. The present invention can set the intensity index lookup table in advance, and then the intensity index lookup table can be utilized to rapidly adjust the intensity setting parameter of the medical scanning apparatus for acquiring the clear and correct detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a medical scanning apparatus according to an embodiment of the present invention.

FIG. 2 is an optical architecture diagram of the medical scanning apparatus according to a first embodiment of the present invention.

FIG. 3 is an optical architecture diagram of the medical scanning apparatus according to a second embodiment of the present invention.

FIG. 4 is a flow chart of a stripe intensity adjustment method according to the embodiment of the present invention.

FIG. 5 is a result diagram of gathering intensity values acquired by the stripe intensity adjustment method according to the embodiment of the present invention.

FIG. 6 is a diagram of a variety trend of the gathering intensity values according to the embodiment of the present invention.

FIG. 7 is a diagram of an intensity adjustment strategy designed by the variety trend of the gathering intensity values according to the embodiment of the present invention.

### DETAILED DESCRIPTION

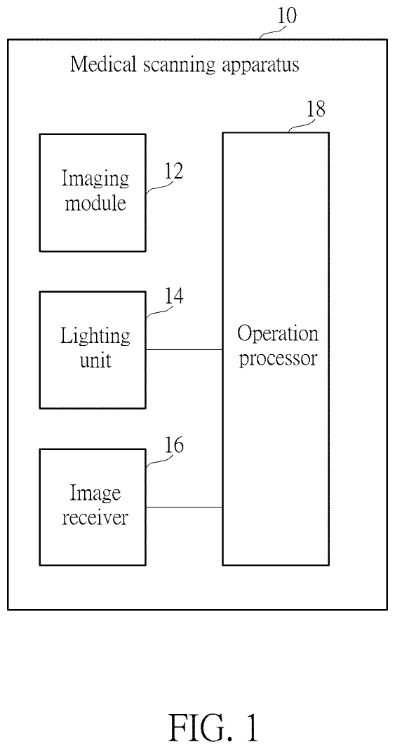

Please refer to FIG. 1. FIG. 1 is a functional block diagram of a medical scanning apparatus 10 according to an embodiment of the present invention. The medical scanning apparatus 10 can include an imaging module 12, a lighting unit 14, an image receiver 16 and an operation processor 18. The lighting unit 14 can emit detection stripes towards the imaging module 12 for projecting onto the target object. The image receiver 16 can receive the stripe pattern reflected by the target object and passing through the imaging module 12. The operation processor 18 can be electrically connected with the lighting unit 14 and the image receiver 16, and can adjust a control parameter of the lighting unit 14 and/or the image receiver 16, so as to analyze the stripe pattern and acquire a 3D outline of the target object.

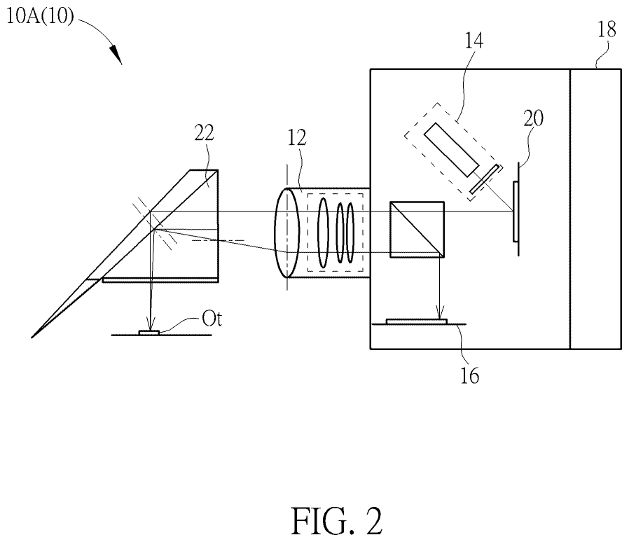

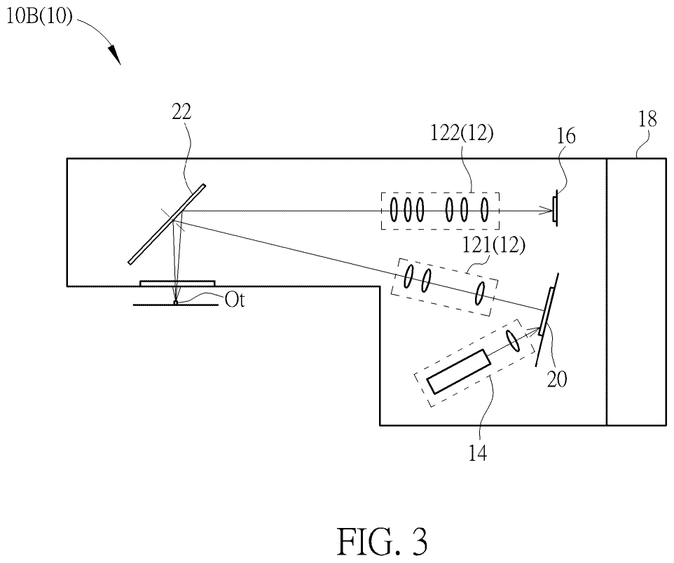

Please refer to FIG. 2 and FIG. 3. FIG. 2 is an optical architecture diagram of the medical scanning apparatus 10A according to a first embodiment of the present invention. FIG. 3 is an optical architecture diagram of the medical scanning apparatus 10B according to a second embodiment of the present invention. As shown in FIG. 2, the lighting unit 14 of the medical scanning apparatus 10A can utilize a projection pattern generator 20 to emit the detection stripes towards the imaging module 12, and the detection stripes can be projected onto the target object Ot via the reflection mirror 22. The stripe pattern reflected by the target object Ot can be received by the image receiver 16 via the reflection mirror 22 and the imaging module 12, and then be transmitted to the operation processor 18 for analysis. The detection stripes and the stripe pattern of the medical scanning apparatus 10A can pass through the same imaging assembly of the imaging module 12.

As shown in FIG. 3, the lighting unit 14 of the medical scanning apparatus 10B can utilize the projection pattern generator 20 to emit the detection stripes towards a first imaging assembly 121 of the imaging module 12. The detection stripes can be projected onto the target object Ot via the reflection mirror 22. The stripe pattern reflected by the target object Ot can be received by the image receiver 16 via the reflection mirror 22 and a second imaging assembly 122 of the imaging module 12, and then transmitted to the operation processor 18 for analysis. The medical scanning apparatus 10 of the present invention can be suitable for various types of optical architectures in accordance with the foresaid two embodiments, and is not limited to the embodiment shown in FIG. 2 and FIG. 3. Variation of the medical scanning apparatus 10 can depend on a design demand, and a detailed description is omitted herein for simplicity.

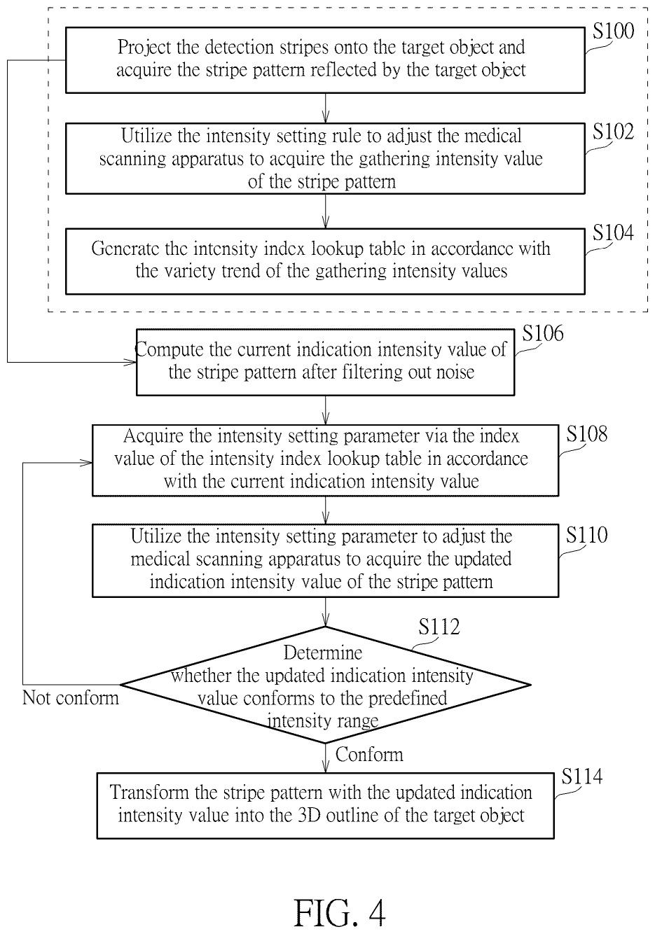

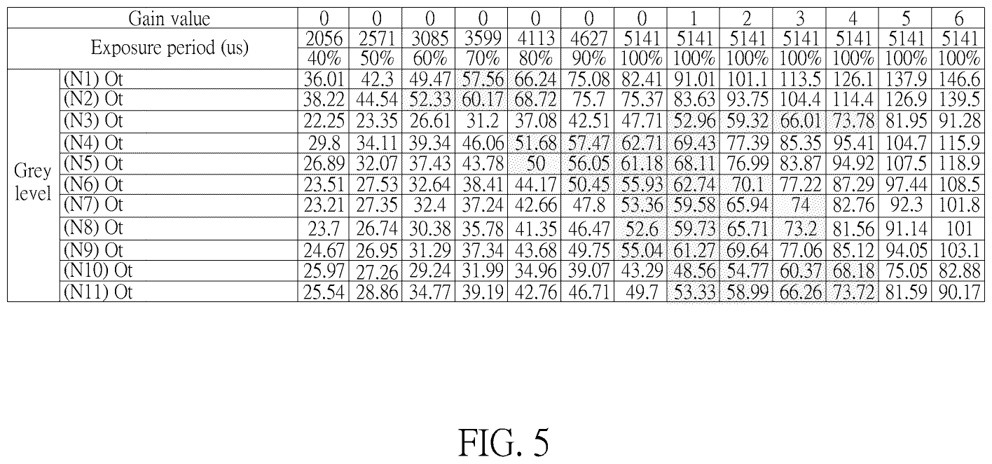

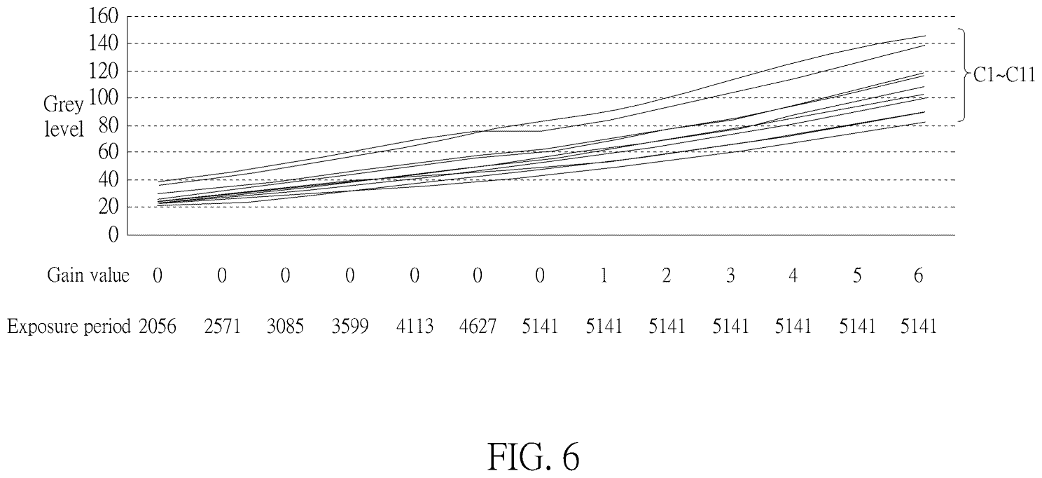

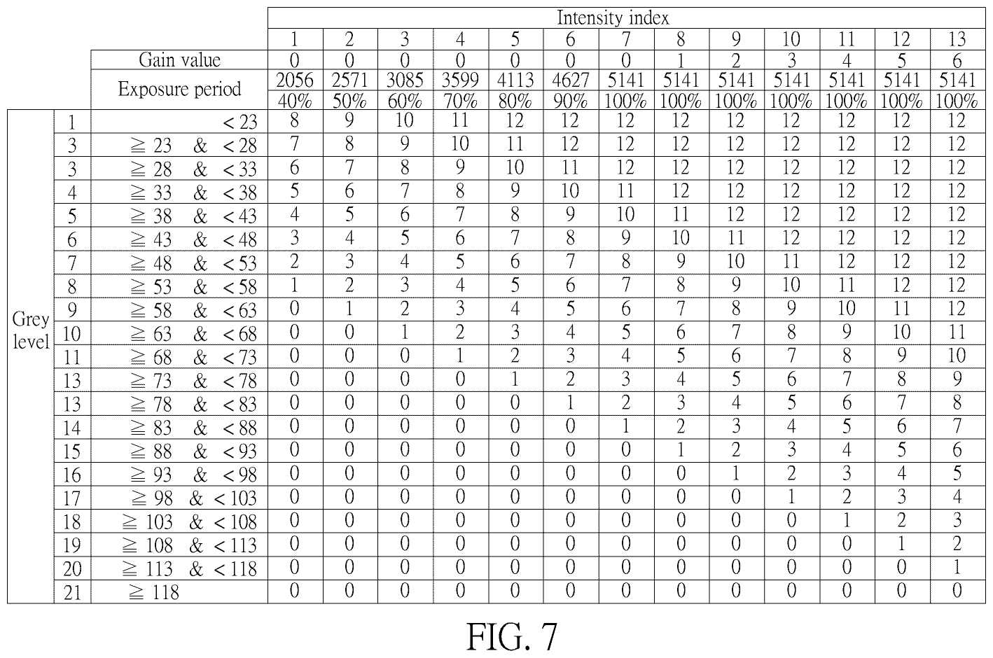

Please refer to FIG. 1 to FIG. 7. FIG. 4 is a flow chart of a stripe intensity adjustment method according to the embodiment of the present invention. FIG. 5 is a result diagram of gathering intensity values acquired by the stripe intensity adjustment method according to the embodiment of the present invention. FIG. 6 is a diagram of a variety trend of the gathering intensity values according to the embodiment of the present invention. FIG. 7 is a diagram of an intensity adjustment strategy designed by the variety trend of the gathering intensity values according to the embodiment of the present invention. The stripe intensity adjustment method illustrated in FIG. 4 can be applied to the medical scanning apparatuses 10, 10A and 10B shown in FIG. 1 to FIG. 3. When a conventional medical scanning apparatus scans a small object with complex shapes, the stripe pattern may be easily affected by the surface color, the material refractive index, the material transmittance and the material reflectivity of the small object; the stripe pattern may be too bright or too dark, which results in decoding errors and incorrect reconstruction of the 3D outline of the small object. The stripe intensity adjustment method of the present invention can collect a series of intensity data of the target object Ot to set the intensity adjustment strategy, for immediately adjusting the intensity of the detection stripes and the stripe pattern and acquiring the correct 3D outline of the target object Ot.

According to the stripe intensity adjustment method, step S100 can be executed to project the detection stripes onto the target object Ot and acquire the stripe pattern reflected by the target object Ot. Then, step S102 can be executed to utilize a plurality of intensity setting rules to adjust the lighting unit 14 and/or the image receiver 16 for acquiring a plurality of gathering intensity values of the stripe pattern respectively. The detection stripes can be generated by the projection pattern generator 20, and can be deformed and reflected by a surface profile of the target object Ot to generate the stripe pattern. Generally, the detection stripes and the stripe pattern can include a basic stripe sequence with periodic repetition, and the basic stripe sequence can include several stripe areas with different widths.

In step S102, the present invention can preset thirteen intensity setting rules, and further set a gain value and an exposure period as adjustment parameters of the intensity setting rule. It should be mentioned that a number and a type of the intensity setting rule are not limited to the foresaid embodiment, for example, the intensity setting rule can be set by adjusting the gain value, the exposure period, a driving current, an actuation point of time, an ending point of time and/or a duration length of the lighting unit 14; or the intensity setting rule can be further set by adjusting the gain value, the exposure period, a sharpness value, a contrast value, the actuation point of time, the ending point of time and/or the duration length of the image receiver 16. Application of the intensity setting rule can depend on the design demand.

As shown in FIG. 5, the gain values used by the thirteen intensity setting rules can be ranged between 0˜6, and the exposure periods used by the thirteen intensity setting rule can be ranged between 2056 μs˜5141 μs. The present invention can set 5141 μs as the maximal exposure period, and further compute other exposure periods via different percentages; however, an actual application of the exposure periods is not limited to the foresaid embodiment. In addition, series numbers N1˜N11 can indicate eleven detection positions of the target object Ot. For example, if the target object Ot is a teeth of a patient, the series numbers N1˜N11 can respectively be out surface of the incisor, the canine and the molar of the patient in different orientations, which depends on application of the medical scanning apparatus 10. Moreover, the present invention can optionally set a predefined intensity range that has grey levels ranged between 50˜75, and the gathering intensity values which are shown in FIG. 5 and ranged within the predefined intensity range can be drawn by shading marks; the predefined intensity range can be set in accordance with the design demand, and the detailed description is omitted herein for simplicity.

Then, step S104 can be executed to generate an intensity index lookup table in accordance with the variety trend of the plurality of gathering intensity values. In FIG. 6, curves C1˜C11 can respectively indicate the variety trend of detection results of the series numbers N1˜N11 of the target object Ot in different intensity setting rules; variation of the grey level and the intensity setting rule of the curves C1˜C11 can show similar trends in response to different initial intensities. In FIG. 7, the intensity adjustment strategy can be interpreted as the intensity index lookup table in step S104. The intensity adjustment strategy can preset an allowable intensity range, such as the allowable intensity range having the grey level ranged between 23˜118; a target grey level can be preset between 58˜63, or the target grey level can be preferably set as grey level 58. Application of the target grey level can depend on the design demand.

Besides, the intensity adjustment strategy can divide the allowable intensity range into a plurality of intensity groups in accordance with a predefined intensity interval. The predefined intensity interval can be a value of 5, and used to divide the allowable intensity range having the grey level ranged between 23˜118 into twenty-one intensity groups. A value of the predefined intensity interval and a number of the intensity group are not limited to the foresaid embodiment, and can be varied in accordance with the actual demand, and the detailed description is omitted herein for simplicity. In FIG. 6, the present invention can further analyze difference between the plurality of gathering intensity values (which can be shown in FIG. 5) and the predefined intensity range (which can be the grey level ranged between 50˜75 as mentioned above) to decide an index value (such as values 0˜12 shown in FIG. 7) related to the variety trend, so as to set the related index values via the intensity setting rules and the intensity groups for generating the intensity index lookup table (which can be interpreted as the intensity adjustment strategy shown in FIG. 7).

When the intensity index lookup table is generated by steps S100, S102 and S104, a generation program of the intensity index lookup table can be completed. Then, the stripe intensity adjustment method of the present invention can perform an execution program of the intensity index lookup table. First, step S100 can be executed to project the detection stripes onto the target object Ot and acquire the stripe pattern reflected by the target object Ot. Then, step S106 can be executed to compute a first indication intensity value of the stripe pattern when noise around the stripe pattern is filtered. In step S106, the present invention can use masking technology to remove the noise around the stripe pattern, so that following steps can preferably analyze the stripe pattern without the noise or with the lower noise to acquire correct data. For example, the present invention can find out a center line of each stripe area of the stripe pattern, and set a stripe range in each stripe area based on the center line of each stripe area in accordance with the predefined stripe width, and compute a pixel grey level of the stripe range to acquire the first indication intensity value of the stripe pattern after filtering out the noise. Therefore, the present invention can use the masking technology to remove the noise, such as a dark shadow or a light spot, around the light and dark edges of the stripe pattern, and the computed first indication intensity value can accurately indicate intensity data of the stripe pattern. Values of the predefined stripe width and the stripe range can be varied in accordance with the design demand.

Then, step S108, step S110 and step S112 can be executed to acquire the intensity setting parameter via the index value of the intensity index lookup table in accordance with a current indication intensity value (which means the first indication intensity value), utilize the intensity setting parameter to adjust the lighting unit 14 or the image receiver 16 for acquiring an updated indication intensity value (which means the second indication intensity value) of the stripe pattern, and determine whether the updated indication intensity value conforms to the predefined intensity range. Please refer to FIG. 5 to FIG. 7. The intensity setting rule which has the gain value set as 0 and the exposure period set as 2056 μs can be used as an example of the initial intensity setting parameter; if the acquired first indication intensity value has the grey level 22.25, the foresaid grey level is defined inside the intensity group less than the grey level 23, so that step S108 can find out the related index value set as 8 from the intensity index lookup table. The index value set as 8 can correspond to another intensity setting parameter that has the gain value set as 2 and the exposure period set as 5141 μs; then, step S110 can use the intensity setting parameter that has the gain value set as 2 and the exposure period set as 5141 μs to adjust the lighting unit 14 or the image receiver 16. If the acquired second indication intensity value of the stripe pattern has the grey level 45, step S112 can determine whether the second indication intensity value conforms to the predefined intensity range having the grey level ranged between 50˜75.

If the second indication intensity value (such as the grey level 45) does not conform to the predefined intensity range (which can be the grey level ranged between 50˜75 as mentioned above), the stripe intensity adjustment method of the present invention can execute step S108, step S110 and step S112 to acquire another intensity setting parameter via another index value of the intensity index lookup table in accordance with the current indication intensity value (which means the second indication intensity value), utilize another intensity setting parameter to adjust the lighting unit 14 or the image receiver 16 fir acquiring the updated indication intensity value (which means a third indication intensity value) of the stripe pattern, and determine whether the updated indication intensity value conforms to the predefined intensity range. For example, when the second indication intensity value (such as the grey level 45) does not conform to the predefined intensity range, another index value set as 11 can be found out from the intensity index lookup table, and the index value set as 11 can correspond to another intensity setting parameter that has the gain value set as 5 and the exposure period set as 5141 μs; when the lighting unit 14 or the image receiver 16 are adjusted by the foresaid intensity setting parameter, the third indication intensity value of the stripe pattern that has the grey level 59.32 can be acquired accordingly. The third indication intensity value that has the grey level 59.32 can be defined inside the predefined intensity range, so that step S114 can be executed to transform the stripe pattern with the updated indication intensity value (which means the third indication intensity value) into the 3D outline of the target object Ot.

If the second indication intensity value that has the grey level 59.32 can be acquired in step S110, step S112 can determine that the second indication intensity value (which means the updated indication intensity value) conforms to the predefined intensity range, and therefore step S114 can be directly executed to transform the stripe pattern with the second indication intensity value (which means the updated indication intensity value) into the 3D outline of the target object Ot. It should be mentioned that the stripe intensity adjustment method of the present invention can identify a code of the stripe area based on center coordinates of each stripe area of the stripe pattern and related configuration and related color, so as to transform the stripe pattern into the 3D outline via the code. The method of transforming the stripe pattern into the 3D outline is not limited to the foresaid embodiment and can be executed by conventional technology or its improvement, and the detailed description is omitted herein for simplicity.

In conclusion, the stripe intensity adjustment method and the related medical scanning apparatus of the present invention can collect data of the target object in advance to set the intensity index lookup table, such as step S100, step S102 and step S104; when the generation program of the intensity index lookup table is completed, the present invention can directly and immediately perform exposure compensation on each detection surface of the target object in following operation, which means step S106, step S108, step S110, step S112 and step S114 can be executed after step S100, without execution of step S102 and step S104. When the indication intensity value of the stripe pattern reflected by the target object after filtering out the surrounding noise conforms to the predefined intensity range, the stripe pattern can be transformed into the 3D outline of the target object. Therefore, the present invention can set the intensity index lookup table in advance, and then the intensity index lookup table can be utilized to rapidly adjust the intensity setting parameter of the medical scanning apparatus for acquiring the clear and correct detection result.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stripe intensity adjustment method applied to a medical scanning apparatus which projects detection stripes onto a target object, the stripe intensity adjustment method comprising:
acquiring a stripe pattern reflected by the target object;
utilizing a plurality of intensity setting rules to adjust the medical scanning apparatus for acquiring a plurality of gathering intensity values of the stripe pattern respectively;
generating an intensity index lookup table in accordance with a variety trend of the plurality of gathering intensity values;
computing a first indication intensity value of the stripe pattern when noise around the stripe pattern is filtered;
acquiring an intensity setting parameter via an index value of the intensity index lookup table in accordance with the first indication intensity value;
utilizing the intensity setting parameter to adjust the medical scanning apparatus for acquiring a second indication intensity value of the stripe pattern; and
transforming the stripe pattern into a 3D outline of the target object when the second indication intensity value conforms to a predefined intensity range.

2. The stripe intensity adjustment method of claim 1, further comprising:
acquiring a center line of each stripe area of the stripe pattern;
setting a stripe range in the stripe area based on the center line in accordance with a predefined stripe width; and
computing a pixel grey level of the stripe range to acquire the first indication intensity value of the stripe pattern after filtering out the noise.

3. The stripe intensity adjustment method of claim 1, wherein each of the plurality of intensity setting rules is setting a gain value, an exposure period, a driving current, an actuation point of time, an ending point of time and/or a duration length of a lighting unit of the medical scanning apparatus.

4. The stripe intensity adjustment method of claim 1, wherein each of the plurality of intensity setting rules is setting a gain value, an exposure period, a sharpness value, a contrast value, an actuation point of time, an ending point of time and/or a duration length of an image receiver of the medical scanning apparatus.

5. The stripe intensity adjustment method of claim 1, further comprising:
setting an allowable intensity range;
dividing the allowable intensity range into a plurality of intensity groups in accordance with a predefined intensity interval; and
setting related index vales by the plurality of intensity setting rules and the plurality of intensity groups to generate the intensity index lookup table.

6. The stripe intensity adjustment method of claim 1, further comprising:
analyzing difference between the plurality of gathering intensity values and the predefined intensity range to decide the index value of the intensity index lookup table corresponding to the variety trend.

7. The stripe intensity adjustment method of claim 1, further comprising:
acquiring another intensity setting parameter via another index value of the intensity index lookup table in accordance with the second indication intensity value when the second indication intensity value does not conform to the predefined intensity range;
utilizing the another intensity setting parameter to adjust the medical scanning apparatus for acquiring a third indication intensity value of the stripe pattern; and
deciding whether to transform the stripe pattern with the third indication intensity value into the 3D outline of the target object, or to acquire other related index values and related intensity setting parameters from the intensity index lookup table in accordance with the third indication intensity value due to a determination result of whether the third indication intensity value conforms to the predefined intensity range.

8. The stripe intensity adjustment method of claim 1, wherein the stripe pattern comprises a basic stripe sequence with periodic repetition and the basic stripe sequence comprises several stripe areas with different widths.

9. The stripe intensity adjustment method of claim 1, wherein the stripe intensity adjustment method identifies a code of the stripe area based on center coordinates of each stripe area of the stripe pattern and related configuration and related color, so as to transform the stripe pattern into the 3D outline via the code.

10. A medical scanning apparatus with stripe intensity adjustment function, comprising:
an imaging module;
a lighting unit adapted to project detection stripes onto a target object through the imaging module;
an image receiver adapted to receive a stripe pattern reflected by the target object and passing through the imaging module; and
an operation processor electrically connected with the lighting unit and the image receiver, the operation processor being adapted to utilize a plurality of intensity setting rules to adjust the medical scanning apparatus for acquiring a plurality of gathering intensity values of the stripe pattern respectively, generate an intensity index lookup table in accordance with a variety trend of the plurality of gathering intensity values, compute a first indication intensity value of the stripe pattern when noise around the stripe pattern is filtered, to acquire an intensity setting parameter via an index value of the intensity index lookup table in accordance with the first indication intensity value, utilize the intensity setting parameter to adjust the medical scanning apparatus for acquiring a second indication intensity value of the stripe pattern, and transform the stripe pattern into a 3D outline of the target object when the second indication intensity value conforms to a predefined intensity range.

11. The medical scanning apparatus of claim 10, wherein the detection stripes and the stripe pattern pass through the same imaging assembly of the imaging module, or the detection stripes and the stripe pattern respectively pass through a first imaging assembly and a second imaging assembly of the imaging module.

12. The medical scanning apparatus of claim 10, wherein the operation processor is adapted to further acquire a center line of each stripe area of the stripe pattern, set a stripe range in the stripe area based on the center line in accordance with a predefined stripe width, and compute a pixel grey level of the stripe range to acquire the first indication intensity value of the stripe pattern after filtering out the noise.

13. The medical scanning apparatus of claim 10, wherein each of the plurality of intensity setting rules is setting a gain value, an exposure period, a driving current, an actuation point of time, an ending point of time and/or a duration length of a lighting unit of the medical scanning apparatus.

14. The medical scanning apparatus of claim 10, wherein each of the plurality of intensity setting rules is setting a gain value, an exposure period, a sharpness value, a contrast value, an actuation point of time, an ending point of time and/or a duration length of an image receiver of the medical scanning apparatus.

15. The medical scanning apparatus of claim 10, wherein the operation processor is adapted to further set an allowable intensity range, divide the allowable intensity range into a plurality of intensity groups in accordance with a predefined intensity interval, and set related index vales by the plurality of intensity setting rules and the plurality of intensity groups to generate the intensity index lookup table.

16. The medical scanning apparatus of claim 10, wherein the operation processor is adapted to further analyze difference between the plurality of gathering intensity values and the predefined intensity range to decide the index value of the intensity index lookup table corresponding to the variety trend.

17. The medical scanning apparatus of claim 10, wherein the operation processor is adapted to further acquire another intensity setting parameter via another index value of the intensity index lookup table in accordance with the second indication intensity value when the second indication intensity value does not conform to the predefined intensity range, utilize the another intensity setting parameter to adjust the medical scanning apparatus for acquiring a third indication intensity value of the stripe pattern, and decide whether to transform the stripe pattern with the third indication intensity value into the 3D outline of the target object, or to acquire other related index values and related intensity setting parameters from the intensity index lookup table in accordance with the third indication intensity value due to a determination result of whether the third indication intensity value conforms to the predefined intensity range.

18. The medical scanning apparatus of claim 10, wherein the stripe pattern comprises a basic stripe sequence with periodic repetition, and the basic stripe sequence comprises several stripe areas with different widths.

19. The medical scanning apparatus of claim 18, wherein the stripe intensity adjustment method identifies a code of each of the stripe areas based on center coordinates of each stripe area of the stripe pattern and related configuration and related color, so as to transform the stripe pattern into the 3D outline via the code.
